(19) United States
(12) Patent Application Publication
(10) Pub. No.: US 2020/0156915 A1
(43) Pub. Date: May 21, 2020

(54) Production Parameter Course View as Part of a User Surface for Monitoring and/or Controlling a Packaging System

(71) Applicant: SIG Technology AG, Neuhausen am Rheinfall (CH)

(72) Inventors: Thomas Hofmann, Osnabrueck (DE); Tim-Niklas Hachmeister, Minden (DE); Jawaher Hamo, Osnabrueck (DE); Nikolaj Freitag, Dueren (DE); Wolfram Peters, Bergheim (DE)

(21) Appl. No.: 16/605,965

(22) PCT Filed: Apr. 17, 2018
(86) PCT No.: PCT/EP2018/059709

§ 371 Date: Oct. 17, 2019

(30) Foreign Application Priority Data
Apr. 21, 2017 (DE) 10 2017 108 546.7

(51) Int. Cl. B67C 3/00; B65B 57/00; G05B 19/418

(52) U.S. Cl. CPC B67C 3/007; G05B 19/4183; G05B 19/41875; B65B 57/00

(57) ABSTRACT

A method is, inter alia, disclosed, which comprises the following: obtaining and/or holding available production parameter information of a packaging system, wherein the production parameter information for one or a plurality of predefined production parameters of the packaging system in each case represents a course recorded for a predefined previous time period; determining at least for each of the predefined production parameters a respective course expected for a predefined future time period at least partially based on the production parameter information; displaying or causing to display a production parameter course view as part of a graphic user surface, wherein a first section of the production parameter course view graphically represents the courses of the predefined production parameters recorded for the predefined previous time period and wherein a second section of the production parameter course view following the first section graphically represents the courses of the predefined production parameters expected for the predefined future time period.

### FIELD

Exemplary embodiments of the invention relate to monitoring and/or controlling a packaging system, in particular the displaying of packaging parameters as part of a user surface for monitoring and/or controlling a packaging system.

### BACKGROUND

Packaging systems such as for example systems for packaging goods such as for example foodstuffs are known. These systems are often monitored or controlled by a single user, wherein current production parameter values of production parameters of the packaging system for example are displayed to the user by corresponding instruments and/or a graphic user interface e.g. in the form of bar graphs, scale displays and/or numeric displays. These displays are frequently unclear and not user-friendly and cannot be displayed or only displayed with difficult by the graphic user interfaces, delimited in the external dimensions, of portable device. In particular in connection with monitoring and controlling packaging systems, it is (unlike other packaging systems) particularly difficult owing to the numerous possible components of such a packaging system to provide a clear and user-friendly display of the production parameters.

### SUMMARY OF SOME EXEMPLARY EMBODIMENTS OF THE INVENTION

The object of the present invention was therefore to overcome one or more of the above-described disadvantages and for example to provide a solution to the clear and user-friendly display of production parameters of a packaging system.

According to the invention, a method is disclosed comprising the following:
obtaining and/or holding available production parameter information of a packaging system, wherein the production parameter information for one or a plurality of predefined production parameters of the packaging system in each case represents a course recorded for a predefined previous time period;
determining at least for each of the predefined production parameters a respective course expected for a predefined future time period at least partially based on the production parameter information;
displaying or causing to display a production parameter course view as part of a graphic user surface, wherein a first section of the production parameter course view graphically represents the courses of the predefined production parameters recorded for the predefined previous time period and wherein a second section of the production parameter course view following the first section graphically represents the courses of the predefined production parameters expected for the predefined future time period.

The method according to the invention is for example a method for monitoring and/or controlling the packaging system or part of such a method.

Furthermore, according to the invention, a computer program is disclosed that comprises program instructions that cause a processor to perform and/or control the method according to the invention when the computer program is executed by the processor. Either all of the steps in the method can be controlled, or all of the steps in the method can be performed, or one or more steps can be controlled and one or more steps performed.

The computer program can for example be shareable via a network such as the internet, a telephone or mobile communications network and/or a local network. The computer program can be at least in part software and/or firmware of a processor. It may be implemented at least partially as hardware.

The computer program is for example contained and/or stored on a computer-readable storage medium. A physical and/or tangible storage medium is for example understood as a computer-readable storage medium.

The computer program is for example a computer program for monitoring and/or controlling the packaging system.

Furthermore, according to the invention, an apparatus is disclosed configured to perform and/or control the method according to the invention or comprising respective means to perform and/or control the steps of the method according to the invention. Either all of the steps of the method according to the invention could be controlled by the means, or all of the steps of the method according to the invention could be performed by the means, or one or more steps can be controlled by the means and one or more steps can be performed by the means. Various steps can optionally be performed or controlled by various means.

The means of the disclosed apparatus can comprise hardware and/or software components. The means can for example comprise a memory with program instructions for a computer program (e.g. the computer program according to the invention) and at least one processor configured to execute program instructions from the at least one memory. Correspondingly, according to the invention, at least one apparatus should be understood to be disclosed which comprises at least one processor and at least one memory with program instructions, wherein the at least one memory and the program instructions are configured to cause, together with the at least one processor, the apparatus to perform and/or to control the method according to the invention.

In addition, the disclosed apparatus can comprise additional means such as for example a communication interface (e.g. to send and/or receive information) and/or a user interface (e.g. a graphic user interface).

The apparatus is for example an apparatus for monitoring and/or controlling the packaging system.

Furthermore, according to the invention, a system is disclosed that comprises the following:
an apparatus according to the invention; and
a packaging system.

The properties and features of the method according to the invention, the computer program according to the invention, the apparatus according to the invention and the system according to the invention are described below, in some cases by means of an example.

A system for packaging goods such as for example foodstuffs is understood by a packaging system. In particular, a packaging system should be understood to mean a beverage filling system and/or a part of a beverage filling system. A large number of different components are frequently used in such systems, for example heating systems (for example heating systems for ultra-high heating of the filled product), filling machines, applicators for attaching closures and/or beverage straws, switch points, case packers and cartoners. Various applications run on these components (e.g. in the form of a computer program executed by a processor of these components).

A production parameter of the packaging system is for example a parameter characteristic of the status of the packaging system and/or a production process performed by the packaging system. Examples of such production parameters are for example a filling quantity per package, a temperature (e.g. a temperature of the filling material), a fill status or a fill level (e.g. in percent; e.g. a fill status of a packaging material magazine of the packaging system or a fill level of a product tank such as a filling material tank of the packaging system), a total system performance of the packaging system and/or a performance of one or a plurality of components of the packaging system (e.g. in number of the packages processed by the packaging system and/or the component(s) per hour), a pressure (e.g. in mbar or bar; e.g. the pressure of a pressurised air supply of the packaging system and/or of a component of the packaging system), a flow (e.g. in ml or l per min or s; e.g. the flow of a cooling fluid in a cooling device of the packaging system), a time specification (e.g. in ms or s or min; e.g. an indication of the remaining time of an ongoing process such as a cleaning process of the packaging system and/or of a component of the packaging system) and/or a volume (e.g. in ml or l; e.g. the volume of the filling material remaining in a product tank such as a filling material tank of the packaging system).

At least some of the components are for example configured to record at least one production parameter value of a production parameter of the packaging system and to send a representation of the at least one recorded production parameter value as production parameter information to the apparatus according to the invention (e.g. to send via a communication connection to the apparatus according to the invention).

Accordingly, obtaining production parameter information is for example understood as the production parameter information being received (e.g. by the apparatus according to the invention via a communication connection). Production parameter information should for example be understood as held available when it is stored in a memory (e.g. in a memory of the device according to the invention). For example, production parameter information is received and then stored in a memory continuously and/or at regular or irregular intervals, which represents in each case production parameter values most recently recorded by the component(s) of the packaging system.

A course of a production parameter (e.g. a recorded and/or expected course) represents for example a development of the respective production parameter in a predefined time period (e.g. a predefined previous and/or future time period).

The fact that the production parameter information for one or a plurality of predefined production parameters of the packaging system in each case represents a course recorded for a predefined previous time period should for example be understood in that the production parameter information for each of the predefined production parameters represents a plurality of production parameter values of the respective production parameter recorded during the predefined previous time period.

Determining a respective course expected for a predefined future time period at least for each of the predefined production parameters takes place for example according to a predefined algorithm. For example, the production parameter information serves as input values of the algorithm. Accordingly, an expected course of a production parameter should for example be understood as a course of the respective production parameter which is obtained as a result of the algorithm. Examples of such an algorithm are for example regression analysis methods (e.g. linear regression methods), self-learning algorithms (e.g. in the form of an artificial neural network or a support vector machine) and extrapolation algorithms (e.g. linear extrapolation). For example, a simple extrapolation algorithm to determine the expected course of a fill status of a packaging material magazine for a predefined future time period as the input values can obtain the most recently recorded total system performance value of the packaging system (e.g. in packages per hour) and the most recently recorded fill status of the packaging material magazine, which are represented by the production parameter information, and, under the assumption that the total system performance value remains unchanged in the predefined future time period, linearly extrapolate the course of the fill status of the packaging material magazine.

For example, the predefined production parameters, the predefined previous time period and/or the predefined future time period can be predefined and/or adjusted at least partially by a user. Alternatively or additionally, the predefined production parameters, the predefined previous time period and/or the predefined future time period can be at least partially fixedly predefined (i.e. be unchangeably predefined for a user).

A respective representation of the predefined production parameters, the predefined previous time period and/or the predefined future time period is for example stored in a memory (e.g. in a memory of the apparatus according to the invention).

The displaying of the production parameter course view as part of the graphic user surface takes place for example by way of a graphic user interface (e.g. a graphic user interface of the apparatus according to the invention). Causing to display the production parameter course view as part of the graphic user surface should for example be understood as the graphic user interface being controlled such that it displays the production parameter course view as part of the graphic user surface.

The graphic user surface is for example a user surface for monitoring and/or controlling the packaging system such as a graphic user surface of a computer program for monitoring and/or controlling the packaging system (e.g. of the computer program according to the invention). The production parameter course view is for example displayed in a part of the graphic user surface (e.g. in a window of the graphic user surface). Additional elements (e.g. a task list and/or a status list) can still be displayed as part of the user surface at the same time as the production parameter course view. For example, the graphic user surface is provided by a graphic user interface by the graphic user interface being controlled such that it displays at least a part of the graphic user surface (e.g. the production parameter course view).

The fact that the first section of the production parameter course view and the second section of the production parameter course view are joined together should for example be understood such that they border one another. The boundary between the first section of the production parameter course view and the second section of the production parameter course view can for example be understood as a transition between these two sections.

The first section of the production parameter course view comprises for example a course diagram which represents (e.g. graphically represents) the recorded courses of the predefined production parameters in the predefined previous time period; and the second section of the production parameter course view comprises for example a course diagram which represents (e.g. graphically represents) the expected courses of the predefined production parameters in the predefined future time period. For example, the different courses are represented in the course diagrams as overlapping course curves with a common X-axis.

As a result, the different predefined production parameters and their development in a common view are displayed to the user such that the user no longer has to switch back and forth between different scale and numeric displays. This is for example advantageous in order to enable a clear and user-friendly display of the production parameter course view, for example also by way of graphic user interfaces of portable devices. The user can also identify for example an unusual trend or outlier in the course of a production parameter through this view without him for example having to previously notice production parameter values recorded for a production parameter.

Further properties and features of the method according to the invention, the computer program according to the invention, the apparatus according to the invention and the system according to the invention are explained below using exemplary embodiments of the invention.

According to an exemplary embodiment of the invention, the production parameter information for each of the predefined production parameters in each case represents a plurality of production parameter values recorded during the predefined previous time period and a current production parameter value of the respective production parameter. In this case, a current production parameter value of the respective production parameter should for example be understood as the production parameter value most recently recorded in each case for this production parameter, which is represented by the production parameter information.

Furthermore, the production parameter information for each represented production parameter value can represent the associated recording time at which the production parameter value was recorded.

As disclosed above, at least some of the components are for example configured to record at least one production parameter value of a production parameter of the packaging system and to send a representation of the at least one recorded production parameter value as production parameter information to the apparatus according to the invention (e.g. via a communication connection to the apparatus according to the invention).

According to an exemplary embodiment of the invention, the production parameter course view for each of the predefined production parameters in each case comprises a course curve associated with the respective production parameter, wherein each of the course curves in each case graphically represents the course recorded and expected for the production parameter associated with the respective course curve. For example, such a course curve (e.g. each of the course curves) can be formed at least partially by a line or curve diagram. Such a line or curve diagram can be obtained for the predefined previous time period for example by connecting the points which represent the recorded production parameter values of the production parameter associated with the respective course curve and the associated recording times, which are represented by the production parameter information for the predefined previous time period.

For example, each of the course curves at the transition between the first and the second section of the production parameter course view represents a current production parameter value of the production parameter associated with the respective course curve. In this case, a current production parameter value of the respective production parameter, as disclosed above, should for example be understood as the production parameter value most recently recorded in each case for this production parameter, which is represented by the production parameter information.

According to an exemplary embodiment of the invention, the transition between the first and the second section of the production parameter course view is graphically highlighted in the production parameter course view. For example, the transition between the first and the second section of the production parameter course view is graphically highlighted by a marking (e.g. a line and/or coloured highlighting and/or a symbol and/or a label).

According to an exemplary embodiment of the invention, the transition between the first and the second section of the production parameter course view is located at a position outside of the centre of the graphic user surface.

The transition between the first and the second section of the production parameter course view being located outside of the centre of the graphic user surface should for example be understood such that, when the production parameter course view is displayed as part of the user surface by a graphic user interface, the centre of the graphic user surface does not contact the transition between the first and the second section of the production parameter course view and/or is not located thereon.

In this case, the geometric focal point of the graphic user surface should be understood as the centre of the graphic user surface, for example the geometric focal point of the user surface provided and/or displayed by a graphic user interface. Accordingly, when the graphic user surface for example takes up a rectangular area on the graphic user interface, the point of intersection of the diagonals of the rectangular area (i.e. of the rectangle formed by the rectangular area) should be understood as the centre of the graphic user surface.

According to an exemplary embodiment of the invention, the production parameter course view extends at least in a direction from a side delimitation of the graphic user surface to an opposing side delimitation of the graphic user surface.

In this case, for example the sides of the area taken up by the graphic user surface on a graphic user interface, which provides and/or displays the graphic user surface, should be understood as a side delimitation of the graphic user surface. Accordingly, the production parameter course view can for example, when the graphic user surface for example takes up a rectangular area on the graphic user interface, extend from one side of the rectangular area (i.e. of the rectangle formed by the rectangular area) to the opposing side of the rectangular area in a direction which runs parallel to the two other sides of the rectangular area.

For example, the production parameter course view takes up a rectangular area on a graphic user interface which displays the production parameter course view as part of the graphic user surface.

According to an exemplary embodiment of the invention, the method further comprises the following:
determining for each of the predefined production parameters at least partially based on the course recorded for the respective production parameter and/or the course expected for the respective production parameter whether the respective production parameter is associable with a predefined production event at a time in the predefined previous time period and in the predefined future time period.

A production result should for example be understood as a desired event (e.g. a production ending event) and/or an undesired event (e.g. a fault event). A production event can for example necessitate an intervention of a user of the packaging system. Examples of such production events are for example a refill event (e.g. exhausting a packaging material reservoir in a packaging material magazine of the packaging system), a soiling or maintenance event (e.g. soiling or wear of a component of the packaging system), a production ending event (e.g. when a predefined number of packages was packaged and/or filled by the packaging system) and/or a fault event (e.g. exceeding or falling short of the temperature of a filling material).

A production parameter should for example then be understood as associable with a predefined production event at a time in the predefined previous time period and in the predefined future time period when the production parameter value of the production parameter indicates that the predefined production event has occurred or will occur at this time.

Determining whether a production parameter is associable with a production event can for example take place according to predefined rules. The predefined rules can for example predefine when the determination should result in that a production parameter is associable with a predefined production event at a time in the predefined previous time period and in the predefined future time period. For example, the rules can predefine threshold values for one or a plurality of production parameters such that, when it emerges from the recorded and/or expected course of a production parameter that a production parameter of the production parameter exceeds or falls below a threshold value predefined for this production parameter at a time, it should be determined that the production parameter is associable with a predefined production event at this time. For example, the rules can predefine that, provided a fill status of a packaging material in a packaging material magazine of the packaging system falls below a threshold value, it should be determined that this production parameter is associable with a refill event

Alternatively or additionally, the determination of whether a production parameter is associable with a production event, can also take place according to a self-learning algorithm (e.g. in the form of an artificial neural network or a support vector machine).

For example, the method further comprises at least one of the following steps if the determining for one of the predefined production parameters results in the production parameter being associable with a predefined production event at a time in the predefined previous time period and/or in the predefined future time period:
highlighting and/or causing to highlight the time and/or the course curve associated with the production parameter in the production parameter course view;
displaying and/or causing to display a production event notification associated with the production event as part of the graphic user surface;
providing and/or causing to provide a user input interface as part of the graphic user surface to open a production event view of the graphic user surface associated with the production event

Since these steps are only performed when the determination of one of the production parameters results in the production parameter being associable with a predefined production event at a time in the predefined previous time period and/or in the predefined future time period, this means for example that the production parameter course view and/or the user surface is influenced only by production events which could actually have occurred and/or could occur. As a result, the attention of the user can be directed to such production events and the production parameter course view and/or the user surface can still be arranged clearly.

The highlighting of the time in the production parameter course view can for example take place by way of graphic highlighting such as for example marking (e.g. a line and/or coloured highlighting and/or a symbol and/or a label). The course curve associated with the production parameter can for example also be graphically highlighted by a marking (e.g. coloured highlighting and/or a change of the line sharpness of the course curve) in the production parameter course view.

As disclosed above, the displaying of the production parameter course view as part of a user surface takes place for example by way of a graphic user interface (e.g. a graphic user interface of the apparatus according to the invention). Causing to highlight should accordingly be understood for example in that the graphic user interface is controlled such that it displays the production parameter course view with corresponding highlighting.

This is for example advantageous in order to make a user aware of the time at which a production event could have occurred and/or could occur, and/or of a production parameter that is associable with the production event.

The displaying of a production event notification associated with the production event as part of the graphic user surface takes place for example by way of a graphic user interface (e.g. a graphic user interface of the apparatus according to the invention). Causing to display the production event notification associated with the production event as part of the graphic user surface should for example be understood as the graphic user interface being controlled such that it displays the production event notification associated with the production event as part of the graphic user surface.

As disclosed above, the graphic user surface is for example a user surface of a computer program for monitoring and/or controlling the packaging system (e.g. of the computer program according to the invention). The production event notification is for example displayed in a part of the graphic user surface (e.g. in a window of the graphic user interface). For example, the production event notification is displayed in a task list and/or in the production parameter course view.

The production event notification contains for example information associated with the production event notification and/or instructions for the user. For example, information associated with a production event notification can display a time of a production event, a type of a production event (e.g. refill event, maintenance or cleaning event and/or fault event) and/or a (or a plurality) of production parameter(s) that can be associated with the production event The instructions associated with a production event notification can for example, when it is a fault event, comprise instructions to fix or avoid the fault event or, when it is a refill event, instructions to refill or, when it is a maintenance or cleaning event, instructions to maintain or clean.

This is for example advantageous in order to display a user information and/or instructions, which are associated with a production event, which could be and/or could occur at a certain time. As a result, the user can for example react particularly quickly to the production event.

Providing a user input interface as part of the graphic user surface takes place for example by way of a graphic user interface (e.g. a graphic user interface of the apparatus according to the invention). Causing to provide the user input interface as part of the graphic user surface should for example be understood as the graphic user interface being controlled such that it displays the user input interface as part of the graphic user surface. An example of a user input interface is for example an element of the user surface that can be activated by a user input (e.g. by a touch input and/or a mouse input) such as a button.

The user input interface to open a production event view, associated with the production event, of the graphic user surface is for example configured to cause a production event view of the graphic user surface associated with the production event to open when it is activated.

The production event view contains for example information associated with the production event notification and/or instructions for the user. As disclosed above, information associated with a production event notification can for example display a time of a production event, a type of a production event (e.g. refill event, maintenance or cleaning event and/or fault event) and/or a (or a plurality) of production parameter(s) that can be associated with the production event. The instructions associated with a production event notification can for example, when it is a fault event, comprise instructions to fix or avoid the fault event or, when it is a refill event, instructions to refill or, when it is a maintenance or cleaning event, instructions to maintain or clean.

This is for example advantageous in order to give a user a simple option to retrieve information and/or instructions, which are associated with a production event, which could have occurred and/or could occur at a certain time. As a result, the user can for example react particularly quickly to the production event

According to an exemplary embodiment of the invention, if the packaging system comprises a plurality of production lines, at least one of the predefined production parameters is a production parameter specific for a production line of the packaging system or is a production parameter averaged over a plurality of production lines.

In this case, a production parameter specific for a production line of the packaging system should for example be understood as a production parameter, whose production parameter values are recorded by a component of this production line of the packaging system.

A production parameter averaged over a plurality of production lines is for example a production parameter, whose production parameter value is an average value of a plurality of production parameters, of which each is in each case specific for a production line of the plurality of production lines. This is for example advantageous in order to enable a clear and user-friendly display of the production parameter course view, for example also by way of graphic user interfaces of portable devices.

According to an exemplary embodiment of the invention, the method further comprises the following:
providing and/or causing to provide a user input interface as part of the graphic user surface to predefine and/or adjust the predefined production parameters, the predefined previous time period and/or the predefined future time period.

As disclosed above, providing a user input interface as part of the graphic user surface takes place for example by way of a graphic user interface (e.g. a graphic user interface of the apparatus according to the invention). Causing to provide the user input interface as part of the graphic user surface should for example be understood as the graphic user interface being controlled such that it displays the user input interface as part of the graphic user surface. An example of a user input interface is for example an element of the user surface that can be activated and/or manipulated by a user input (e.g. by a touch input and/or a mouse input) such as a button, a control box or a slide control.

The user input interface to predefine and/or adjust the predefined production parameters, the predefined previous time period and/or the predefined future time period is for example configured to enable the predefining and/or adjusting of the predefined production parameters, the predefined previous time period and/or the predefined future time period by a corresponding user input.

It is understood that additional user input interfaces may be part of the graphic user surface.

According to an exemplary embodiment of the invention, the production parameter course view is displayed as part of the user surface by a graphic user interface of a portable apparatus. For example, the apparatus according to the invention is a portable apparatus.

For example, a portable apparatus should be understood as an apparatus, whose external dimensions are smaller than 330 mm×250 mm×20 mm, preferably smaller than 250 mm×200 mm×15 mm, particularly preferably smaller than 160 mm×80 mm×8 mm.

Examples of a portable apparatus are a smartphone, a tablet computer or a notebook computer.

The exemplary embodiments and exemplary configurations of the present invention described above should also be understood to be disclosed in all combinations.

Further advantageous exemplary embodiments of the invention can be drawn from the following detailed description of a number of exemplary embodiments of the invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features contained in the drawings should in no way be deemed a necessary element of the present invention.

In the drawings:

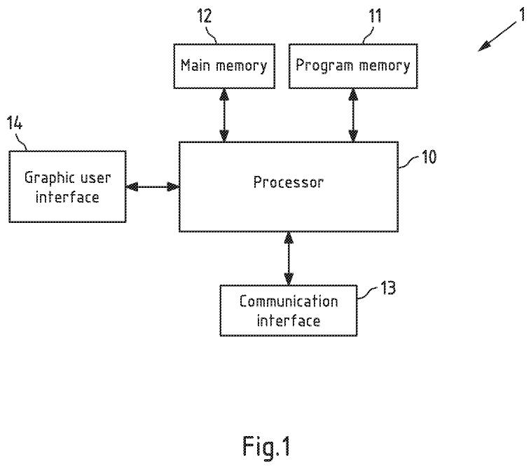

FIG. 1 shows a schematic representation an exemplary embodiment of an apparatus according to the invention;

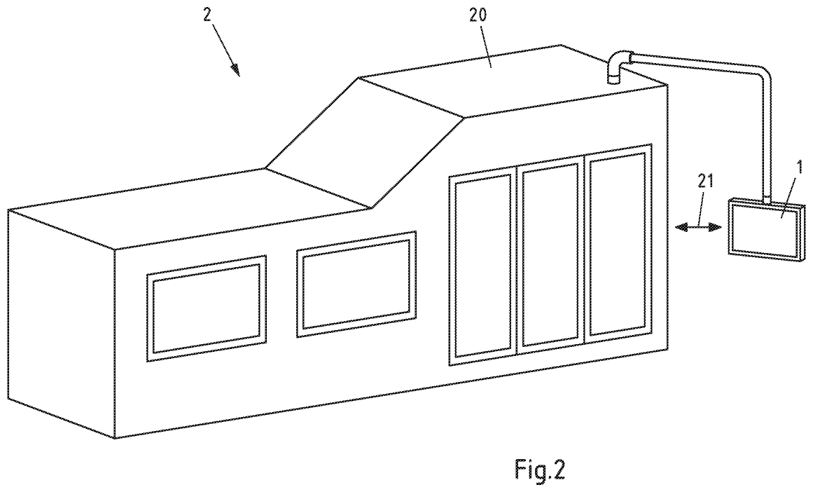

FIG. 2 shows a schematic representation of an exemplary embodiment of a system according to the invention;

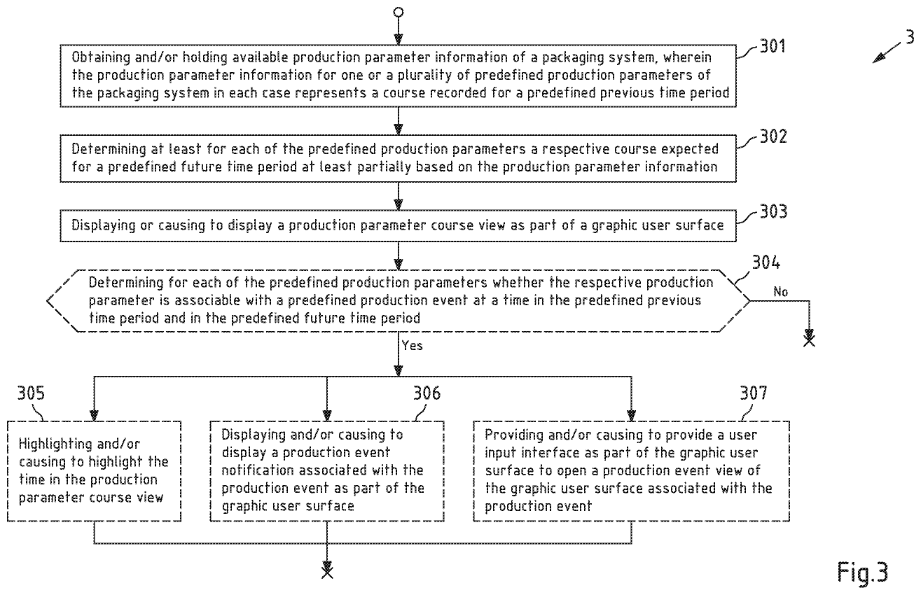

FIG. 3 shows a flow diagram of an exemplary embodiment of a method according to the invention;

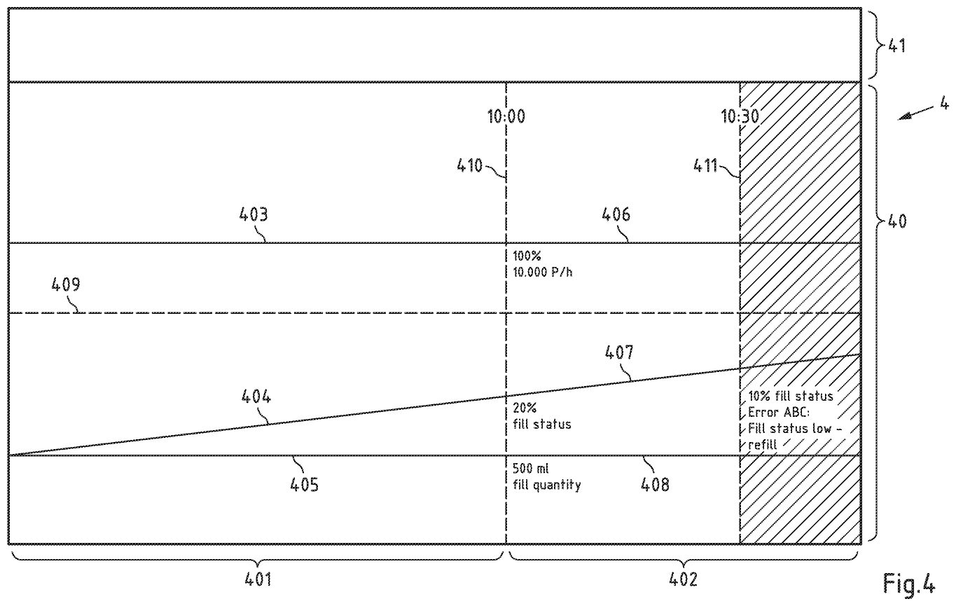

FIG. 4 shows an exemplary display of a graphic user surface with a production parameter course view; and

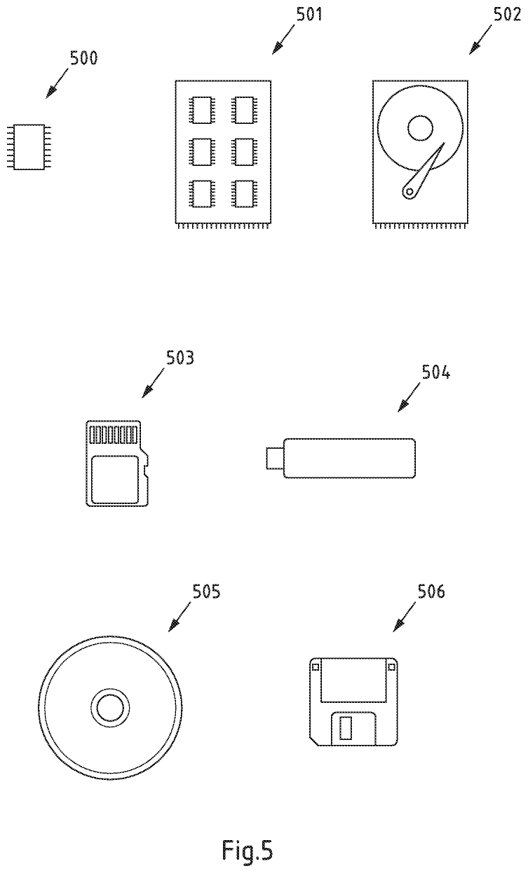

FIG. 5 shows exemplary embodiments of storage media.

### DETAILED DESCRIPTION OF A NUMBER OF EXEMPLARY EMBODIMENTS OF THE INVENTION

FIG. 1 is a schematic representation of an exemplary embodiment of an apparatus according to the invention. The apparatus according to the invention is represented as apparatus 1 in FIG. 1.

The apparatus 1 comprises by way of example a processor 10 and connected to the processor 10 a first memory as a program and data memory 11, a second memory as a main memory 12 and a communication interface 13 and a graphic user interface 14.

A processor should for example be understood to be a microprocessor, a microcontrol unit, a microcontroller, a Digital Signal Processor (DSP), an Application-Specific Integrated Circuit (ASIC) or a Field Programmable Gate Array (FPGA). It should be understood that the apparatus 1 can also comprise a plurality of processors 10.

Processor 10 runs program instructions that are stored in the program memory 11 and stores for example interim results or the like in the main memory 12. The program memory 11 contains for example program instructions of a computer program according to the invention which comprises program instructions which cause the processor 10 to perform and/or control the method according to the invention (for example the method according to the flow chart 3 shown in FIG. 3) when the processor 10 execute these program instructions stored in the program memory 11.

Program memory 11 for example also contains the operating system of the apparatus which, on starting the apparatus, is, at least in some cases, loaded into the main memory 12 and executed by the processor 10. In particular, upon starting apparatus, at least a part of the core of the operating system is loaded in the main memory 12 and executed by the processor 10.

An example of an operating system is a Windows, UNIX, Linux, Android, Apple iOS and/or Mac OS operating system. In particular, the operating system makes it possible to use the portable apparatus for data processing. For example, it administers tools such as a main memory and a program memory, provides fundamental functions among other things through programming interfaces with other computer programs and controls the executing of computer programs.

A program memory is for example a non-volatile memory such as a flash drive, a magnetic memory, an EEPROM memory (electrically erasable programmable read-only memory) and/or an optical memory. A main memory is for example a volatile or non-volatile memory, in particular a memory with random-access (RAM) such as a static RAM memory (SRAM), a dynamic RAM memory (DRAM), a ferroelectric RAM memory (FeRAM) and/or a magnetic RAM memory (MRAM).

The main memory 12 and the program memory 11 can also be formed as one memory. Alternatively, the main memory 12 and/or the program memory 11 can each be formed by a plurality of memories. Furthermore, the main memory 12 and/or the program memory 11 can also be part of the processor 10.

Processor 10 controls the communication interface 13. A communication interface can for example receive information according to a communication technique via a communication path and/or a communication connection and provide it to the processor 10 and/or receive information from the processor 10 and send it according to a communication technique via a communication path and/or a communication connection. Examples of such communication techniques are communication networks and their specifications such as Ethernet networks and/or WLAN networks and/or real-time Ethernet networks such as EtherCAT and/or mobile communication networks such as GSM, UMTS and/or LTE networks. An example of a communication interface is, accordingly, a network adapter such as an Ethernet and/or WLAN and/or EtherCAT and/or a mobile communication network adapter.

Furthermore, processor 10 controls the graphic user interface 14. For example, the graphic user interface 14 is configured to display a graphic user surface (e.g. a graphic user surface of a computer program executed by the processor 10). For example, the graphic user interface 14 is a screen such as a touch-sensitive screen.

The components 10 to 14 of the apparatus 1 are for example connected with one another for communication and/or operating purposes via one or a plurality of bus systems (for example one or a plurality of serial and/or parallel bus connections).

It is understood that, in addition to the components 10 to 14, the apparatus 1 can comprise further components such as for example input and output means (e.g. a keyboard and/or a mouse).

The apparatus 1 can for example be formed as a portable apparatus (e.g. as a tablet computer).

FIG. 2 is a schematic representation of an exemplary embodiment of a system 2 according to the invention with a packaging system 20 and an apparatus 1, which is fastened to a holder of the packaging system 20, and can communicate (e.g. receive and/or send information such as production parameter information) via a communication connection 21 with the packaging system 20 and/or components of the packaging system 20. It is assumed below that the apparatus 1 corresponds to the apparatus 1 from FIG. 1.

The packaging system 20 is for example a beverage filling system and/or a part of a beverage filling system. A large number of different components are frequently used in such systems, for example heating systems (for example heating systems for ultra-high heating of the filled product), filling machines, applicators for attaching closures and/or beverage straws, switch points, case packers and cartoners.

At least some of the components of the packaging system 20 are configured to record at least one production parameter value of a production parameter of the packaging system 20 and to send a representation of the at least one recorded production parameter value as production parameter information to the apparatus 1 via the communication connection 21.

In this case, a production parameter of the packaging system 20 is for example understood as a parameter characteristic of the status of the packaging system 20 and/or a production process executed by the packaging system 20. Examples of such production parameters are a filling quantity per package, a temperature (e.g. a temperature of the filling material), a fill status or a fill level (e.g. a fill status of a packaging material magazine of the packaging system or a fill level of a product tank such as a filling material tank of the packaging system), a total system performance of the packaging system 20 and/or a performance of one or a plurality of components of the packaging system 20 (e.g. a number of packages per hour processed by the packaging system and/or the component(s)), a pressure (e.g. the pressure of a pressurised air supply of the packaging system 20 and/or a component of the packaging system 20), a flow (e.g. the flow of a cooling fluid in a cooling device of the packaging system 20), a time specification (e.g. an indication of the remaining time of an ongoing process such as a cleaning process of the packaging system 20 and/or a component of the packaging system 20), and/or a volume (e.g. the volume of the filling material remaining in a product tank such as a filling material tank of the packaging system).

FIG. 3 shows a flow diagram 3 with steps of an exemplary embodiment of a method according to the invention. In the following, it is assumed by way of example that the steps 301 to 307 of the flow chart 3 are performed by the apparatus 1, which is part of the system 2 (see FIG. 2).

In a step 301, production parameter information of the packaging system 20 is obtained at the apparatus 1 and/or held available by the apparatus 1, wherein the production parameter information for one or a plurality of predefined production parameters of the packaging system 20 in each case represents a course recorded for a predefined previous time period.

For example, the production parameter information of the packaging system 20 is received in step 301 at least partially by the communication interface 13 via the communication 21 from the packaging system. Alternatively or additionally, the production parameter information of the packaging system 20 can be stored at least partially in program memory 11 of the apparatus 1.

For example, production parameter information, which represents in each case production parameter values most recently recorded by the component(s) of the packaging system, is received by the communication interface 13 via the communication connection 21 and then stored in a program memory 11 continuously and/or at regular or irregular intervals. Accordingly, the production parameter information for each of the predefined production parameters for example represents a plurality of production parameter values of the respective production parameter recorded during the predefined previous time period.

In a step 302, a respective course expected for a predefined future time period is determined at least for each of the predefined production parameters at least partially based on the production parameter information.

The determination in step 302 can take place according to a predefined algorithm. For example, the production parameter information serves as input values of the algorithm. Accordingly, an expected course of a production parameter should for example be understood as a course of the respective production parameter which is obtained as a result of the algorithm. Examples of such an algorithm are, as disclosed above, regression analysis methods (e.g. linear regression methods), self-learning algorithms (e.g. in the form of an artificial neural network or a support vector machine) and extrapolation algorithms (e.g. linear extrapolation).

In a step 303, a production parameter course view is displayed as part of a graphic user surface or the display of the production parameter course view is caused, wherein a first section of the production parameter course view graphically represents the courses of the predefined production parameters recorded for the predefined previous time period and wherein a second section of the production parameter course view following the first section graphically represents the courses of the predefined production parameters expected for the predefined future time period.

FIG. 4 shows an exemplary display of a graphic user surface 4 with such a production parameter course view 40. The graphic user surface is for example a user surface of a computer program stored in program memory 11 and executed by the processor 10 for monitoring and/or controlling the packaging system 20.

As emerges from FIG. 4, the production parameter course view 40 is for example displayed in a part of the graphic user surface 4 below a task or status list 41, which is also part of the user surface 4.

The production parameter course view 40 comprises a first section 401 and a second section 402. The first section 401 of the production parameter course view comprises for example a course diagram which represents the recorded courses 403-405 of the predefined production parameters in the predefined previous time period; and the second section of the production parameter course view comprises for example a course diagram which represents the expected courses 406-408 of the predefined production parameters in the predefined future time period. For example, the different courses are represented in the course diagrams as overlapping course curves (see 403-408) with a common X-axis 409.

In the production parameter course view, a recorded and expected course of the system performance in package per hour is for example represented by the course curves 403 and 406, a recorded and expected course of a fill status of a packaging material magazine by the course curves 404 and 407 and a recorded and expected course of the fill quantity per package by the course curves 405 and 408.

The transition between the first section 401 and the second section 402 of the production parameter course view 40 is for example highlighted in FIG. 4 by a line 410 and the label “10:00”, which displays the current time.

Furthermore, the user surface 4 can provide one or a plurality of user input interfaces, for example to predefine and/or adjust the predefined production parameters, the predefined previous time period and/or the predefined future time period. Alternatively or additionally, the predefined production parameters, the predefined previous time period and/or the predefined future time period can be at least partially fixedly predefined (i.e. be unchangeably predefined for a user). An example of a user input interface is an element of the user surface 4 that can be activated and/or manipulated by a user input (e.g. by a touch input and/or a mouse input) such as a button, a control box or a slide control.

A respective representation of the predefined production parameters, the predefined previous time period and/or the predefined future time period is for example stored in a memory (e.g. in program memory 11 or main memory 12).

In an optional step 304, it is determined for each of the predefined production parameters at least partially based on the course recorded for the respective production parameter and/or the course expected for the respective production parameter whether the respective production parameter is associable with a predefined production event at a time in the predefined previous time period and in the predefined future time period.

As disclosed above, a production event should for example be understood as an event that necessitates an intervention of a user of the packaging system 20. Examples of such production events are for example a refill event (e.g. exhausting a packaging material reservoir in a packaging material magazine of the packaging system), a soiling or maintenance event (e.g. soiling or wear of a component of the packaging system), a production ending event (e.g. when a predefined number of packages was packaged and/or filled by the packaging system) and/or a fault event (e.g. exceeding or falling short of the temperature of a filling material).

Determining whether a production parameter is associable with a production event can for example take place according to predefined rules. The predefined rules can for example predefine when the determination should result in that a production parameter is associable with a predefined production event at a time in the predefined previous time period and in the predefined future time period. For example, the rules can predefine threshold values for one or a plurality of production parameters such that when it emerges from the recorded and/or expected course of a production parameter that a production parameter of the production parameter exceeds or falls below a threshold value predefined for this production parameter at a time, it should be determined that the production parameter is associable with a predefined production event at this time. It is for example assumed below that the rules predefine that, provided a fill status of a packaging material in a packaging material magazine of the packaging system falls below a threshold value of 10%, it should be determined that this production parameter is associable with a refill event.

When the determination in step 304 at least for one of the predefined production parameters results in the production parameter being associable with a predefined production event at a time in the predefined previous time period and/or in the predefined future time period, the method is for example continued with one or a plurality of optional steps 305 to 307. Otherwise, the method is for example ended.

In the step 305, the time of the production event is highlighted or caused to be highlighted in the production parameter course view.

The highlighting of the time in the production parameter course view can for example take place by way of graphic highlighting such as for example marking (e.g. a line and/or coloured highlighting and/or a symbol and/or a label). The course curve associated with the production parameter can for example also be graphically highlighted by a marking (e.g. coloured highlighting and/or a change of the line sharpness of the course curve) in the production parameter course view.

In the production parameter course view shown in FIG. 4, the time 10:30, at which the fill status of the packaging material magazine falls below the threshold value of 10%, is highlighted by the line 411 and the label “10:30”.

In the step 306, a production event notification associated with the production event is displayed as part of the graphic user surface or the display of the production event notification is caused.

The production event notification contains for example information associated with the production event notification and/or instructions for the user. For example, information associated with a production event notification can display a time of a production event, a type of a production event (e.g. refill event, maintenance or cleaning event and/or fault event) and/or a (or a plurality) of production parameter(s) that can be associated with the production event The instructions associated with a production event notification can for example, when it is a fault event, comprise instructions to fix or avoid the fault event or, when it is a refill event, instructions to refill or, when it is a maintenance or cleaning event, instructions to maintain or clean.

In the production parameter course view shown in FIG. 4, shading of the time period, in which the fill status of the packaging material magazine is below the threshold value of 10%, is an example of such a production event notification and the displayed notification: “10% fill status error ABC:Fill status low—refill” represented, wherein “Error ABC” for example is an error code.

In the step 306, a user input interface is provided or is caused to be provided as part of the graphic user surface 4 to open a production event view of the graphic user surface 4 associated with the production event The production event view contains for example information associated with the production event notification and/or instructions for the user.

FIG. 5 shows exemplary embodiments of storage media on which an exemplary embodiment of a computer program according to the invention can be stored. The storage medium can for example be a magnetic, electric, optic and/or other type of storage medium. The storage medium can for example be part of a processor (e.g. processor 10 of the portable apparatus 1 from FIG. 1), for example a (non-volatile or volatile) program memory of the processor or a part of this. Exemplary embodiments of a storage medium are a flash memory 500, an SSD hard drive 501, a magnetic hard drive 502, a memory card 503, a memory stick 504 (for example a USB stick), a CD-ROM or DVD 505 or a diskette 506.

The exemplary embodiments of the present invention described in this specification should also be understood as being disclosed in all combinations with each other. In particular, the description of a feature included by an embodiment, provided the opposite is not explicitly explained, should also not be understood in the present case as the feature being necessary or essential for the function of the exemplary embodiment. The sequence of the method steps in the individual flow diagrams outlined in this specification is not absolutely necessary, alternative sequences of the method steps are conceivable, unless otherwise indicated. The method steps can be implemented in a different manner, thus an implementation in software (by program instructions), hardware or a combination of the two in order to implement the method steps is conceivable.

Terms used in the claims such as “comprise”, “have”, “contain”, “include” and the like do not exclude additional elements or steps. The wording “at least partially” includes both the case of “partially” and also the case of “fully”. The wording “and/or” should be understood as both the alternative and the combination being disclosed, i.e. “A and/or B” means “(A) or (B) or (A and B)”. A plurality of units, individuals or the like means multiple units, individuals or the like in the context of this specification. The use of the indefinite article does not exclude a plurality. An individual device can perform the functions of a plurality of units or devices mentioned in the claims. Reference numerals indicated in the claims should not be considered as limitations of the means and steps used.

1.A method comprising:
at least one of obtaining or holding available production parameter information of a packaging system, wherein the production parameter information for one or a plurality of predefined production parameters of the packaging system in each case represents a course recorded for a predefined previous time period;
determining at least for each of the predefined production parameters a respective course expected for a predefined future time period at least partially based on the production parameter information;
displaying or causing to display a production parameter course view as part of a graphic user surface, wherein a first section of the production parameter course view graphically represents the courses of the predefined production parameters recorded for the predefined previous time period, wherein a second section of the production parameter course view following the first section graphically represents the courses of the predefined production parameters expected for the predefined future time period, and wherein, when the production parameter course view is displayed as part of the graphic user surface, the transition between the first and the second section of the production parameter course view is located at a position outside of the centre of the graphic user surface such that the centre of the graphic user surface does not contact die transition between die first and the second section of the production parameter course view or is not located thereon.

2. The method according to claim 1, wherein the production parameter information for each of the predefined production parameters in each case represents a plurality of production parameter values recorded during the predefined previous time period and a current production parameter value of the respective production parameter.

3. The method according to claim 1, wherein the production parameter course view for each of the predefined production parameters in each case comprises a course curve associated with the respective production parameter and wherein each of the course curves in each case graphically represents the course recorded and expected for the production parameter associated with the respective course curve.

4. The method according to claim 3, wherein each of the course curves at the transition between the first and the second section of the production parameter course view represents a current production parameter value of the production parameter associated with the respective course curve.

5. The method according to claim 1, wherein the transition between the first and the second section of the production parameter course view is graphically highlighted in the production parameter course view.

6. (canceled)

7. The method according to claim 1, further comprising
determining for each of the predefined production parameters at least partially based on at least one of the course recorded for the respective production parameter or the course expected for the respective production parameter whether the respective production parameter can be associated with a predefined production event at a time in the predefined previous time period and in the predefined future time period.

8. The method according to claim 7, wherein the method further comprises at least one of the following steps if the determining for one of the predefined production parameters results in the production parameter being associable with a predefined production event at a time in at least one of the predefined previous time period or the predefined future time period:
highlighting or causing to highlight the time in the production parameter course view;
displaying or causing to display a production event notification associated with the production event as part of the graphic user surface;
providing or causing to provide user input interface as part of the graphic user surface to open a production event view of the graphic user surface associated with the production event.

9. The method according to claim 1, wherein if the packaging system comprises a plurality of production lines, at least one of the predefined production parameters is a production parameter specific for a production line of the packaging system or is a production parameter averaged over a plurality of production lines.

10. The method according to claim 1, further comprising:
providing or causing to provide a user input interface as part of the graphic user surface to predefine or adjust at least one of the predefined production parameters, the predefined previous time period or the predefined future time period.

11. A non-transitory computer readable storage medium on which a computer program is stored, the computer program comprising program instructions which cause a processor to perform or control the method according to claim 1, when the computer program is executed by the processor.

12. An apparatus comprising at least one processor and at least one memory including computer program code, wherein the at least one memory and the computer program code are configured to, together with the at least one processor, cause the apparatus to perform or control:
obtaining or holding available production parameter information of a packaging system, wherein the production parameter information for one or a plurality of predefined production parameters of the packaging system in each case represents a course recorded for a predefined previous time period;
determining at least for each of the predefined production parameters a respective course expected for a predefined future time period at least partially based on the production parameter information;
displaying or causing to display a production parameter course view as part of a graphic user surface, wherein a first section of the production parameter course view graphically represents the courses of the predefined production parameters recorded for the predefined previous time period, wherein a second section of the production parameter course view following the first section graphically represents the courses of the predefined production parameters expected for the predefined future time period, and wherein, when the production parameter course view is displayed as part of the graphic user surface, the transition between the first and the second section of the production parameter course view is located at a position outside of the centre of the graphic user surface such that the centre of the graphic user surface does not contact the transition between the first and the second section of the production parameter course view or is not located thereon.

13. (canceled)

14. The method according to claim 1, wherein at least one of the predefined previous time period or the predefined future time period is fixedly predefined such that they are unchangeably for a user.

15. The apparatus according to claim 12, wherein the production parameter information for each of the predefined production parameters in each case represents a plurality of production parameter values recorded during the predefined previous time period and a current production parameter value of the respective production parameter.

16. The apparatus according to claim 12, wherein the production parameter course view for each of the predefined production parameters in each case comprises a course curve associated with the respective production parameter and wherein each of the course curves in each case graphically represents the course recorded and expected for the production parameter associated with the respective course curve.

17. The apparatus according to claim 16, wherein each of the course curves at the transition between the first and the second section of the production parameter course view represents a current production parameter value of the production parameter associated with the respective course curve.

18. The apparatus according to claim 12, wherein the transition between the first and the second section of the production parameter course view is graphically highlighted in the production parameter course view.

19. The apparatus according to claim 12, wherein the at least one memory and the computer program code are further configured to, together with the at least one processor, cause the apparatus to further perform or control:
determining for each of the predefined production parameters at least partially based on at least one of the course recorded for the respective production parameter or the course expected for the respective production parameter whether the respective production parameter can be associated with a predefined production event at a time in the predefined previous time period and in the predefined future time period.

20. The apparatus according to claim 19, wherein the at least one memory and the computer program code are further configured to, together with the at least one processor, cause the apparatus to further perform or control at least one of the following steps if the determining for one of the predefined production parameters results in the production parameter being associable with a predefined production event at a time in at least one of the predefined previous time period or the predefined future time period:
highlighting or causing to highlight the time in the production parameter course view;
displaying or causing to display a production event notification associated with the production event as part of the graphic user surface;
providing or causing to provide a user input interface as part of the graphic user surface to open a production event view of the graphic user surface associated with the production event.

21. The apparatus according to claim 12, wherein if the packaging system comprises a plurality of production lines, at least one of the predefined production parameters is a production parameter specific for a production line of the packaging system or is a production parameter averaged over a plurality of production lines.

22. The apparatus according to claim 12, wherein the at least one memory and the computer program code are further configured to, together with the at least one processor, cause the apparatus to further perform or control
providing or causing to provide a user input interface as part of the graphic user surface to predefine or adjust at least one of the predefined production parameters, the predefined previous time period or the predefined future time period.

23. The apparatus according to claim 12, wherein at least one of the predefined previous time period or the predefined future time period is fixedly predefined such that they are unchangeably for a user.
